(19) United States
(12) Patent Application Publication
(10) Pub. No.: US 2006/0210141 A1
(43) Pub. Date: Sep. 21, 2006

(54) Inspection method and inspection apparatus

(75) Inventors: Kazuto Kojitani, Osaka (JP); Atsushi Shimizu, Yokohama-shi (JP); Hiroshi Tasaki, Nara-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/376,285

(22) Filed: Mar. 15, 2006

(30) Foreign Application Priority Data
Mar. 16, 2005 (JP) 2005-074673

(51) Int. Cl. G06K 9/46; G06K 9/00

(52) U.S. Cl. 382/141; 382/190; 382/149

(57) ABSTRACT

An inspection method and an inspection apparatus are disclosed, wherein the appropriate inspection can be conducted in accordance with the situation change of a nonconforming product from an initial stage, an adjust stage and a stable stage. The conformity/nonconformity is discriminated according to a MTS model and a one class SVM model based on the normal data obtained from a conforming product. The conformity/nonconformity is discriminated by both the MTS and the one class SVM in an adjust stage where a sufficient amount of sample data cannot be acquired or the shape of the conforming product distribution in the feature space and the shape of the normal area are unstable, and only by the MTS in a stable stage where a sufficient amount of sample data can be acquired and the shape of the conforming product distribution and the shape of the normal area are stable.

### BACKGROUND OF THE INVENTION

1. Field of the Invention

This invention relates to an inspection method and an inspection apparatus, or more in particular, to an inspection method for extracting the feature amount from the input measurement data of an object to be inspected and discriminating the current state based on the extracted feature amount and an inspection apparatus for carrying out the inspection using the inspection method.

2. Description of the Related Art

In the high-mix low volume production age, the manufacturing industry encounters the serious problem of how quickly to start the production line as well as how to secure the product quality. Specifically, a simple high accuracy inspection algorithm is not sufficient, and production sites are required to meet the following needs as described below to send quality goods to the market.

The first need is the automation of inspection. Specifically, the inspection in the production process is conducted to control the quality by determining the control standard for each characteristic value such as the size and weight of individual products. For example, in the inspection apparatus in which the solder appearance test of a printed wiring board and the sensory test such as the noise test of an automotive engine, a plurality of quality characteristics are extracted from the image and the waveform and the conformity/nonconformity of the product quality is discriminated overall based on a discrimination model.

The second need is vertical start. It is common practice at the production site, to start a mass production line through trial production. During the trial production, products are manufactured by the same production means as in mass production after research and design to determine the feasibility of mass production including whether the process is free of any problems. In the case where the discrimination model of the automatic inspection apparatus is automatically generated, modeling is impossible unless sufficient data is collected, and therefore an inspection standard cannot be established before starting mass production. In order to achieve vertical start, it is important to determine, in the test mass production stage, the inspection standard used for mass production, and to start stable inspection as soon as mass production has begun.

FIG. 1 shows the stages (processes) from the start of development of a given product (work) to the start of the final mass production line and the relation of samples between a conforming product (OK) and a nonconforming product (NG) obtained from each process. Specifically, research is started on a target outline of the product (research stage), followed by a specific design (design stage), and initial mass production of the designed product (trial production stage). After confirming that the trial production is free of problems, actual mass production is started and the mass production line is activated (mass production stage).

After starting mass production, some trouble, such as a nonconforming product may unexpectedly occur that is corrected each time (unstable mass production stage); thereafter the cause of the product nonconformity is traced and obviated. As a result the product defect rate is extremely reduced for an improved yield (stable mass production stage). Specifically, even after starting mass production, nonconforming products may occur and may be detected, and in the case where the cause thereof is derived from the improper discrimination rule, the inspection standard is corrected (the feature amount and/or the inspection range is changed). In the case where a nonconforming product occurs, the cause is traced without changing the inspection standard, so that mass production continues while carrying out countermeasures against the cause of the trouble (design change).

As shown in FIG. 1, in the research and design stages, few products are actually produced (trial production) (initial test production stage). Especially in the research stage, there are an extremely small number of samples of nonconforming products (works). As a result, the distribution areas for normality and abnormality each have a small range. Upon transfer to the design stage, many trials and errors lead to an increased number of nonconforming products and a greater variety of causes of the nonconformity. As a result, a plurality of abnormality areas is discovered.

Upon transfer to the mass production stage, there is an increase in the number of samples produced and the cause of the nonconformity unexpected in the research and design stage is detected, thereby increasing the number of defective or nonconforming products. The unexpected causes of the nonconformity specifically include nonconformity attributable to mistakes during the production process. As can be understood from the distribution image, a great variety of causes of nonconformity are involved in the mass production stage, and therefore a plurality of abnormality areas are spotted, resulting in an increase in the number of spots and samples in each area, beyond those in the design stage. Also, due to the great variety of abnormality areas, a plurality of areas determined as conforming (normal) may exist. With the progress of the mass production stage, the cause of the nonconformity is frequently traced and the resulting solution is used to improve the production equipment and the production line. Thus, nonconforming products are generated less frequently while at the same time obviating the cause of the nonconformity, thereby reducing the number of areas in which nonconforming products are manufactured.

At the start of mass production, the number of conforming products increases, while the number of nonconforming products decreases; the types of nonconformities also decrease. Additionally, the variation between the manufactured products gradually decreases, thereby reducing the conformity area. This phenomenon becomes more conspicuous during the transition from an unstable to stable mass production stage.

In such a situation, to quickly begin mass production, an attempt to conduct conformity/nonconformity discrimination in the initial stages in order to positively and accurately specify nonconforming products using a conventional inspection apparatus, encounters the following problems.

Specifically, in the starting period (design, trial production) of the production line when the nonconformity rate of products is high and a plurality of nonconformity factors work in combination or a multiplicity of unknown nonconforming types exist, the conformity/nonconformity discrimination based on the sample data of nonconforming products lacks the proper sample data on nonconforming products, and the inspection apparatus cannot be used effectively. Even in the case where sample data of a nonconforming product can be prepared and the inspection apparatus constructed, the cause of the nonconformity is sought at the time of starting the production line, while at the same time conceiving a solution to the nonconformity to improve the production equipment and the production line. As a result, the nonconforming products providing the basis of the sample data used in constructing the inspection apparatus are often already eliminated by a solution on the one hand and new nonconformity types of products arise on the other hand, thereby posing the problem that an effective inspection apparatus cannot be provided.

### SUMMARY OF THE INVENTION

According to one aspect of the invention, there is provided an inspection method for extracting the feature amount of the input measurement data and discriminating the conformity/nonconformity of an object to be inspected, based on the extracted feature amount, characterized in that the conformity/nonconformity is determined in accordance with a model based on the normal data obtained from a conforming product, and a stage where a sufficient amount of sample data cannot be acquired or the shape of the conforming product distribution in the feature space is unstable and the estimation accuracy of the shape of the normal area is insufficient, the measurement data of the object to be inspected is subjected to both discrimination based on a parametric discrimination model and discrimination based on a nonparametric discrimination model; based on both the discrimination results, conformity/nonconformity is determined. On the other hand in a stage where a sufficient amount of samples can be acquired and the shape of the conforming product distribution and the shape of the normal area are stable, the measurement data of the object to be inspected is subjected to conformity/nonconformity discrimination based only on the discrimination result of a parametric discrimination model.

According to another aspect of the invention, there is provided an inspection method for extracting the feature amount of the input measurement data and discriminating the conformity/nonconformity of an object to be inspected, based on the extracted feature amount, characterized in that conformity/nonconformity is determined in accordance with a model based on the normal data obtained from a conforming product; in a stage where only a small amount of sample data can be acquired and the conforming product distribution in the feature space or the shape of the normal area cannot be estimated, conformity/nonconformity discrimination based on the measurement data of the object to be inspected is determined using only the discrimination result by a nonparametric discrimination model, while in a stage where a sufficient amount of sample data cannot be acquired or the shape of the conforming product distribution in the feature space with the unstable shape of the normal area and therefore the shape of the normal area cannot be estimated accurately, the determination of the measurement data of the object to be inspected is made by both a parametric discrimination model and a nonparametric discrimination model, and conformity/nonconformity is determined based on the result of both the parametric and nonparametric discrimination, and further, while in a stage where a sufficient amount of sample data can be acquired and the shape of the conforming product distribution and the shape of the normal area are stable, the conformity/nonconformity discrimination based on the measurement data of the object to be inspected is made using only the discrimination result by the parametric discrimination model.

According to still another aspect of the invention, there is provided an inspection apparatus for extracting the feature amount of the input measurement data and determining the state of an object to be inspected, based on the extracted feature amount, thereby discriminating the conformity/nonconformity in accordance with a model based on the normal measurement data obtained from a conforming product. The apparatus comprising the function of determining the conformity/nonconformity by a parametric discrimination model and the function of determining the conformity/nonconformity by a nonparametric discrimination model, characterized in that the function of determining the conformity/nonconformity by the parametric discrimination model and the function of discriminating the conformity/nonconformity by the nonparametric discrimination model can be executed independently of each other or at the same time. The control means operates in such a manner that in the stage where a sufficient amount of sample data cannot be acquired or the shape of the conforming product distribution in the feature space is unstable resulting in an insufficient estimation accuracy of the shape of the normal area, both the function of discriminating the conformity/nonconformity of the measurement data of the object by the parametric discrimination model and the function of discriminating the conformity/nonconformity by the nonparametric discrimination model are executed and the final conformity/nonconformity discrimination is made based on the discrimination result of both functions. On the other hand, while in a stage where a sufficient amount of sample data can be acquired and the shapes of the conforming product distribution and the normal area are stable, the conformity/nonconformity discrimination is made based only on the function of conformity/nonconformity discrimination by the parametric discrimination model on the measurement data of the object to be inspected.

### BRIEF DESCRIPTION OF THE DRAWINGS

FIG. 1 shows the stages (processes) from the starting the development of a given product (work) to the complete starting of the final normal mass production line and the relation between the conforming products and the samples of nonconforming products obtained in each process;

FIG. 2 shows an embodiment of the invention;

FIG. 3 shows an example of the internal configuration of an inspection apparatus 10;

FIG. 4 shows a more detailed internal structure;

FIG. 5A shows a diagram for explaining the MTS principle, and FIG. 5B the one class SVM principle;

FIG. 6 is a diagram showing an SVM support vector;

FIG. 7 shows a diagram for explaining non-linear mapping with SVM;

FIG. 8 shows a Gaussian kernel function as used with a one class SVM;

FIG. 9 shows a diagram for explaining the operation in the initial stage;

FIG. 10 shows a diagram for explaining the operation in the adjust stage;

FIG. 11 shows a diagram for explaining the operation in the stable stage;

FIG. 12 shows an example of the fuzzy rule in the adjust stage;

FIG. 13 shows a flowchart of a general configuration according to a first embodiment;

FIG. 14 shows a flowchart of an example of the processing function in the initial stage;

FIG. 15 shows a flowchart of an example of the processing function in the adjust stage;

FIG. 16 shows a flowchart of an example of the processing function in the stable stage;

FIG. 17 shows a flowchart of a general configuration according to a second embodiment;

FIG. 18 shows a flowchart of a general configuration according to a third embodiment; and

FIG. 19 shows the operation of the third embodiment;

### DETAILED DESCRIPTION OF THE PREFERRED EMBODIMENTS

Embodiments of the invention are specifically described below. Although each embodiment explained in this specification uses the waveform data based on the sound and vibration as measurement data, the invention is not limited to these measurement data but can also use the measurement data of such as the image signal, temperature, rotational speed and torque.

In an inspection method and an inspection apparatus for conducting the inspection using the inspection method, a plurality of feature amounts are extracted and used based on the waveform obtained from different domains including the time domain and the frequency domain.

For example, general noise inspection is conducted based on a plurality of feature amounts simply because all noises cannot be detected by the noise inspection method based only on the feature amount obtained from the waveform along time axis or the feature amount obtained from the waveform along the frequency axis. This is due to the fact that each feature amount has both advantages and disadvantages. A noise inspection method using a plurality of feature amounts has higher discrimination ability than a noise inspection method using a single feature amount.

With the increase in the number of the feature amounts used, the discrimination rules for conformity/nonconformity discrimination are complicated more or required in a greater number. In order to carry out the noise inspection of high accuracy, therefore, the discrimination rule is required to be formed with high accuracy. An application of this invention makes it possible to form a discrimination rule in high accuracy.

Further, an application of the invention can produce the effect of automatically producing the discrimination rule.

The inspection method and the inspection apparatus according to an embodiment of the invention uses the technique of forming a normal area having conforming products using a model based on normal data for normality determination in the case where the detection value is within the normal area and as abnormal in the case where the detection value is not included in the normal area.

A resulting feature then, is that the discrimination based on the nonparametric discrimination model and/or the discrimination based on the parametric discrimination model alternate with each other in accordance with the production stage.

In the nonparametric method, all the data already observed or a part of the data contributing to the discrimination are held as they are as a learning for each group, and in the case where new data are observed at the time of discrimination, the identity with the particular group is determined from the analogy to or distance from the data held thereby to determine the association or dissociation with the particular group.

As a specific example of the nonparametric method, a one class support vector machine (one class SVM) is used in the description of embodiments hereinafter. As an alternative, a method can be employed in which all the data are held and when new data are observed, k data are extracted in the ascending order of Euclidean distance from the data thus held, and in the case where the average value is not less than a predetermined value, the nonconformity is determined. The one class SVM is the discrimination based on the comparison with a case, and determines a product as “conforming if the sound and waveform are near to those of a conforming product experienced in the past” thereby to detect other than the products determined as conforming positively. In the stage where data are still few, therefore, products other than nonconforming one are detected, thereby often leading to excessive detection. Being the “nonparametric method”, however, the learning is possible even from a small number of conforming product samples, and therefore the inspection is possible even in the stage of test production and test mass production where sufficient samples cannot be collected. Also, in the case where the multivariate normality can be assumed and sufficient amount of data are available, the discrimination result is substantially coincident with that of the parametric method.

In the parametric method, the parameters (mean or distribution, for example) for defining the shape of the probability density distribution followed by the data associated with each of groups (normal, for example) made up of the data already observed are estimated by learning, and in the case where new data are observed at the time of discrimination, the association with the particular group is determined using the estimated parameter thereby to determine the identity with the particular group.

In the embodiments described hereinafter, MTS (Mahalanobis-Taguchi System) is shown as a specific example of the parametric discrimination model. As an alternative, assuming that the probability density distribution followed by a conforming product group is a normal distribution, the means and the standard deviation constituting the shape parameter thereof are estimated, and when new data are observed, the posterior probability of the particular data being associated with the particular group is determined. Then, the nonconformity is determined for those with the probability not more than a predetermined value. In MTS, the probability density distribution followed by the conforming product group is assumed as a multivariate normal distribution, the means and the standard deviation constituting the shape parameters thereof are estimated, and when new data are observed, the nonconformity is determined for those products of which the Mahalanobis distance from the observed data to the conforming product group (determined from the mean and the distribution) is of not less than a predetermined value. Specifically, products having the sound and waveform near to those of the ideal conforming products as discriminated based on comparison with a model are determined as conforming. Therefore, this method is an approach from the quality control for controlling the mean and variations, and the standard for discrimination is explained.

By application of this invention, normality (no abnormality) is determined based on the normal (conforming product) data base, and therefore even in the case where the nonconforming data are lacking or very few, the inspection becomes possible. Even in the case where the normal data are few, the inspection is possible. Further, with the increase in data, the accuracy of abnormality detection can be improved.

As a result, various nonconforming cases including ambiguous nonconformity can be detected, and the proper inspection is made possible in accordance with the situation change (the process from initial test production to test mass production to mass production) of the appearance of nonconforming products (nonconforming situation) which may occur in the product manufacture.

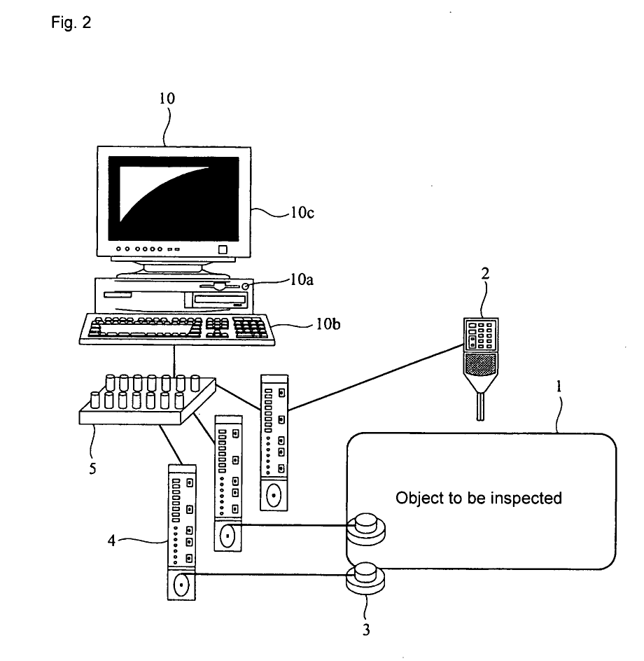

A first embodiment of the invention is explained in detail with reference to the drawings. FIG. 2 shows an example of a configuration according to this embodiment. As shown in FIG. 2, according to this embodiment, signals from a microphone 2 and an acceleration pickup 3 located in contact with or proximity to an object 1 to be inspected are amplified by an amplifier 4, and after being converted to digital data by an A/D converter 5, applied to an inspection apparatus 10. Though not shown, the operation timing and other data can be obtained from the PLC in charge of control for actual manufacturing of a work (product) in the production field in the stage of test mass production or after starting the mass production. The inspection apparatus 10 acquires the waveform data based on the sound data collected by the microphone 2 and the vibration data collected by the acceleration pickup 3 and thus extracts a feature amount, while at the same time discriminating the conformity/nonconformity. As apparent from FIG. 2, the inspection apparatus 10 is configured of a computer and includes a CPU body 10a, an input device 10b such as a keyboard and a mouse and a display 10c. Also, the inspection apparatus 10, if required, may include an external storage unit or a communication function for communication with an external data base to acquire the required information.

Also, according to this embodiment, the discrimination knowledge used for conformity/nonconformity discrimination is generated based on the normal sample, and a basic algorithm is for abnormality discrimination is used to determine a product meeting the conditions as a conforming product and a product not meeting the conditions as a nonconforming product. With this configuration, the inspection apparatus 10 according to this embodiment can make the conformity/nonconformity discrimination in each period of the test mass production before the mass production, the initial period of mass production (line start) and the subsequent stable period of mass production.

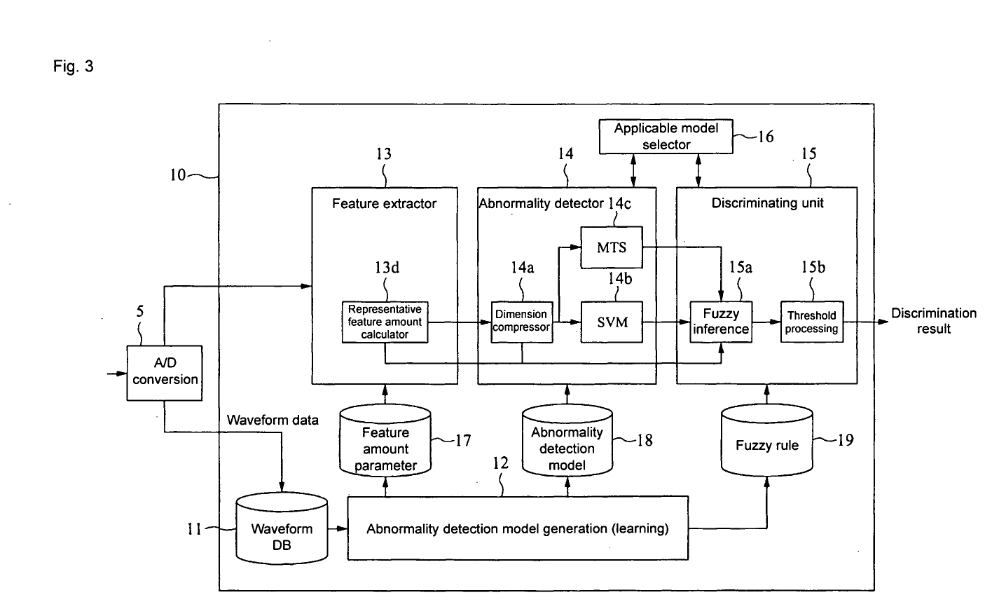

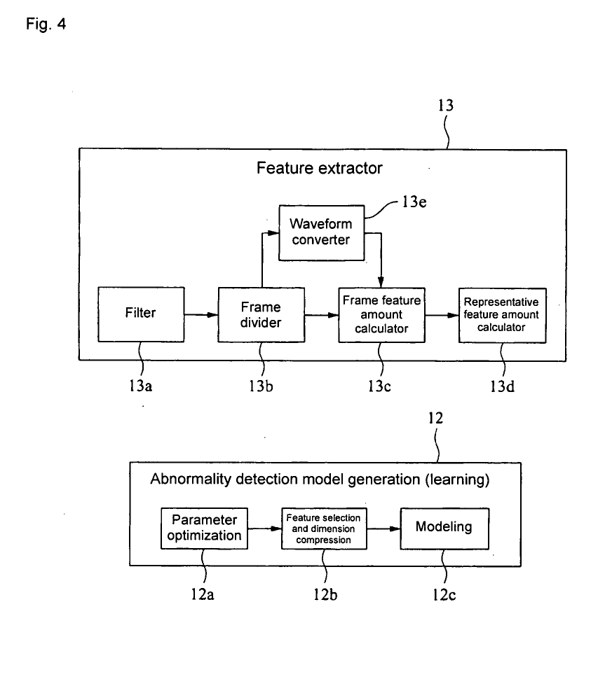

FIG. 3 shows the internal configuration mainly of the inspection apparatus 10, and FIG. 4 the more detailed internal configuration. The inspection apparatus 10 has the function of creating the knowledge required for conformity/nonconformity discrimination and the function of making the conformity/nonconformity discrimination based on the knowledge thus created. According to this embodiment, both functions are performed based on the normal conforming products, and in accordance with each stage from development to production, the knowledge is automatically corrected to make the conformity/nonconformity discrimination suitable for each stage.

As the function of creating the knowledge, the inspection apparatus 10 includes a waveform database 11 for storing the waveform data acquired through the A/D converter 5. According to this embodiment, the waveform data base 11 has stored therein the waveform data generated based on the normal products (conforming products). Nevertheless, the abnormal waveform data generated based on nonconforming products may of course be stored as an alternative. The abnormal waveform data can be used for the performance inspection (whether the nonconformity can be correctly discriminated or not) of the inspection apparatus 10.

To generate a model (determination rule), only the data on the conforming products are stored. In inspection apparatus 10 however, the model is improved and corrected, whenever necessary, in each stage from the time before starting the mass production to the time after starting the mass production thereby to construct a model for better discrimination. Initially, therefore, the sample waveform data of a conforming product is prepared, and stored in the waveform data base 11. Once a certain number of sample waveform data are prepared, the inspection for conformity/nonconformity discrimination is actually conducted while at the same time further collecting the sample data, and the model is reconstructed based on the collected sample data (data to be inspected).

The waveform data input through the A/D converter 5, therefore, are applied to the feature amount extractor 13 for the conformity/nonconformity discrimination at the time of inspection, while at the same time being stored in the waveform data base 11. As to the waveform data stored in this way, however, it is not known whether they are associated with a conforming product or not. The waveform data on a conforming product is used for model reconstruction. Therefore, though not shown, the discrimination result is fed back to the waveform data stored in the waveform data base 11. Specifically, the data structure of the waveform data base 11 is a table structure relating the actual waveform data to the normality/abnormality discrimination. Further, since the discrimination result is fed back and related, the code (for which the record No. can be used) for identifying each waveform data is required. The sample data on a conforming product provided in the initial stage of course constitute normal data and require no discrimination. Also, even the waveform data determined as abnormal can be upgraded to “normal” and used for model preparation in the case where the conformity is determined by the human being.

The normal waveform data stored in the waveform data base 11 is accessed by the abnormality detection model generating unit 12 and the knowledge required for conformity/nonconformity discrimination is created. The knowledge created in this case includes the feature amount parameter and the abnormality detection model. The feature amount parameter created is stored in the feature amount parameter data base 17, and the abnormality detection model is stored in the abnormality detection model data base 18. Further, the apparatus has the function of creating a fuzzy rule for conformity/nonconformity discrimination by the discrimination unit 15 as described later.

Also, the inspection apparatus 10 includes a feature amount extractor 13 for extracting the feature amount from the waveform data acquired through the A/D converter 5, an abnormality detector 14 for determining whether the value of the feature amount is included in the normal area or not and in the case where it is not included in the normal area, detecting an abnormality, the discrimination unit 15 for finally discriminating the conformity/nonconformity (conformity/nonconformity discrimination) based on the detection result of the abnormality detector 14, and an applicable model selector 16 for determining and selecting a model used for the abnormality detection process. The discrimination result of the discrimination unit 15 is displayed in real time, for example, on the display 10c or stored in a storage unit.

Before explaining the functions and the structure of each processing unit in detail, the abnormality detection algorithm according to this embodiment is explained.

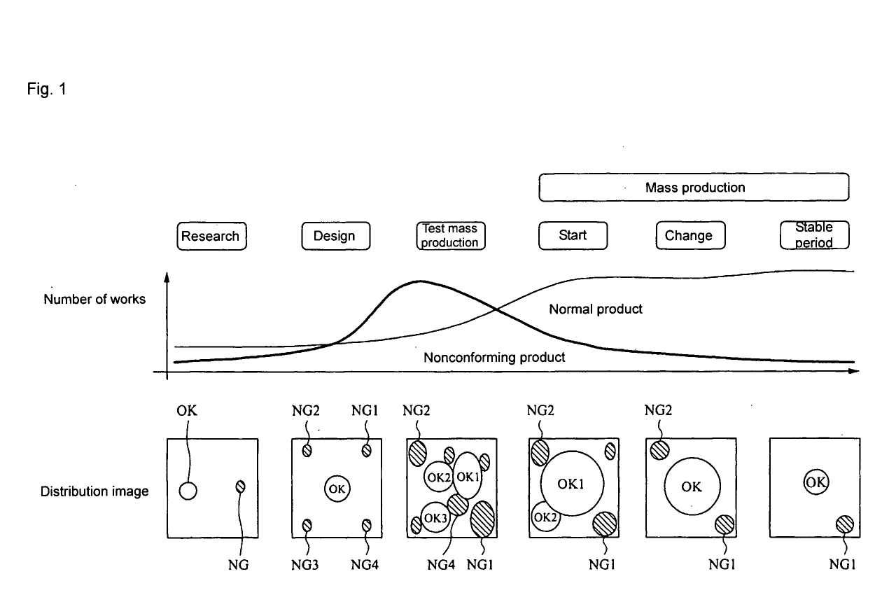

As apparent from FIG. 1, the number and characteristic of the data on the number and characteristics of data constituting each group of conforming products and nonconforming products in each process from the product research/design stage to the mass production stage cannot be obtained. Specifically, after starting the mass production, the nonconforming products occur at a rate so low that a sufficient number of data cannot be acquired. Before starting the mass production, on the other hand, the occurrence of nonconforming products, though high, is temporary and immediately improved. Therefore, nonconforming products due to the same cause, i.e. the feature amount based on the waveform data of the nonconforming products having the same type of feature amount is less liable to occur subsequently. Further, in both periods, the nonconformity can be classified into various categories according to the cause and should not be reasonably considered in one class. Furthermore, the numbers of samples that can be used for modeling the conforming and nonconforming products, respectively, are not symmetric with each other. According to this embodiment, therefore, a one class discrimination method such as the probability density estimation is used based on the normal waveform data derived from conforming products.

Also, the statistic characteristic of the value of the feature amount of the normal waveform data based on conforming products according to this embodiment is not expected to form a normal distribution as long as the samples collected are few in number. At least after starting the mass production, however, the normal distribution (multivariate normal distribution) is expected to be realized. In the case where the normal distribution can be assumed, the parametric method can be used for modeling, while otherwise, the only modeling technique that can be used is the nonparametric method.

According to this embodiment, therefore, the parametric method is used in the case where a multivariate normal distribution can be expected as the statistic characteristic of the data (feature amount value) obtained from conforming products, and the nonparametric method is used otherwise. In the case where the conformity/nonconformity discrimination is made continuously from the stage before mass production by the inspection apparatus 10 according to this embodiment, however, the number of sample data obtained (including the actual data on objects to be inspected) gradually increases. Therefore, the statistic characteristic of the feature amount value is not changed to the multivariate normal distribution instantaneously at a given moment, but there exists a transition period accompanied by ambiguity. Should there exist a moment when the statistical characteristic changes (theoretically) to the multivariate normal distribution, it is difficult to define a particular moment to switch the model from nonparametric to parametric method.

In view of this, according to this embodiment, the conformity/nonconformity discrimination is made using both the parametric and nonparametric methods during the transition period, while once a comparatively accurate discrimination becomes possible by the parametric method such as after starting the mass production, the discrimination is made simply by the parametric method. A second embodiment is realized based on this idea.

In the case where the number of samples is small or it is apparent that normal distribution is lacking due to the skewness or deviation, the reliability of the result of the conformity/nonconformity discrimination by the parametric method is of course low, and therefore the function of discrimination simply by the nonparametric modeling method should be added. The first embodiment of the invention is realized based on this idea.

According to this embodiment, MTS (Mahalanobis-Taguchi-Schmidt) method is used as a parametric technique. Specifically, according to the MTS method, an ordinary mass in some sense of the word such as a conforming product mass is set. This is called a unit space. In discriminating a conforming product, a conforming product is set as a unit space. Once the unit space and the observation variable are set, the mean vector and the variance/covariance matrix constituting the basis of the Mahalanobis' generalized distance described below is estimated only from the samples for the unit space alone.

The Mahalanobis distance is a scalar value indicating the distance from the mean vector as an origin taking the variance/covariance matrix, i.e. the variable correlation into consideration, as expressed by the following equation.
Δ²=(x−μ)′Σ⁻¹(x−μ) (1)
where Σ is the variance/covariance matrix, and μ the mean vector.

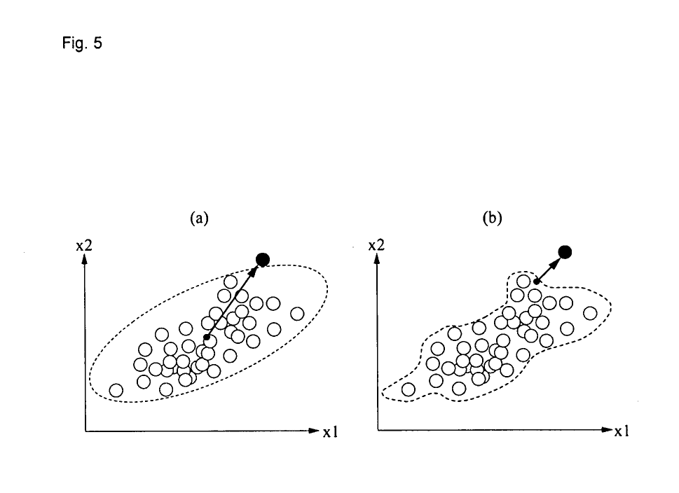

As described above, the Mahalanobis distance calculated from samples of conforming products is regarded as an amount indicating the deviation from the conforming product group. Specifically, as shown in FIG. 5A, the normal distribution leads to the fact that the hyperellipsoid (the area indicated by dashed line in FIG. 5A) in which the Mahalanobis distance from the distribution center is equal as desired represents a conforming product range, and the area deviating from the estimated distribution (a predetermined equidistant range of the hyperellipsoid) is detected as an abnormal area. In FIG. 5A, the product indicated by the black circle, for example, is out of the range and discriminated as abnormal (nonconforming).

In the conformity/nonconformity discrimination using the parametric method, the lower limit of the number of data is at least not less than the number of features, or preferably (empirically), the data not less than three times as many as the features are required.

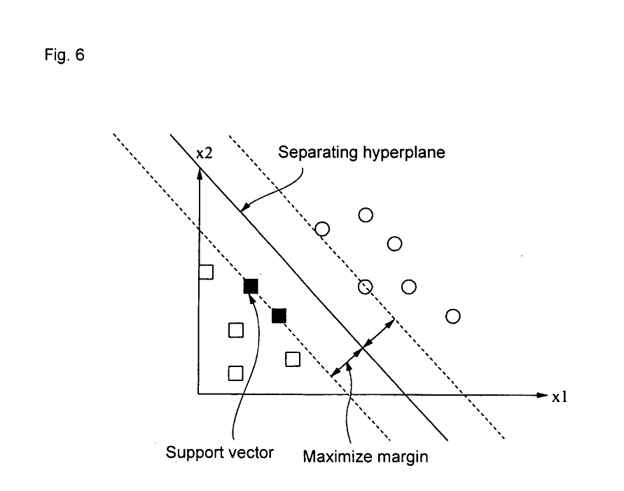

According to this embodiment, on the other hand, the method called the one class SVM (support vector machine) is used as a nonparametric method. This SVM is a learning machine produced for solving the two-class discrimination problem. The SVM has the feature that the nonlinear discrimination function can be configured also by the mapping of the input data to a high-dimension space called the Kernel conversion. In the SVM, the minimum distance between the separating hyperplane and the sample data capable of best discriminating the sample data is used as an evaluation formula, and the separating hyperplane is determined in such a manner as to maximize the particular minimum distance. The sample data corresponding to the maximized minimum distance is called the support vector (FIG. 6). The support vector is determined only by the boundary data.

Assuming that the mass of n d-dimensional data x={x1, . . . ,xd} is used as sample data, the discrimination function by SVM is expressed as follows.

$$f ( Φ ( x ) ) = {\sum }_{j = 1}^{n} {α}_{i} {y}_{i} K ( x , {x}_{j} ) + b \qquad ( 2 )$$

where yi is the label of the sample data, and αi a parameter called the support vector weight. Also, character b designates a parameter called a bias item, φ the mapping by Kernel conversion, and K(x, y) the inner product in the space after mapping.

The mass (identification surface) of points meeting the relation f(x)=0 in this discrimination constitutes the d•1-dimensional hyperplane.

According to the Kernel method, SVM is expanded nonlinearly, and therefore, the nonlinear mapping is carried out with the nonlinear mapping φ. With the increase in dimension, therefore, the resulting complication normally makes calculation difficult. In the case of SVM, on the other hand, the object function and the identification function are dependent only on the inner product of the input patterns, and therefore once the inner product is calculated, the optimum identification function can be configured. In this way, while mapping in high dimensions, the feature calculation in the mapped space is actually avoided, and replaced by the Kernel function. To configure the optimum identification function simply by calculation of the Kernel function is called the Kernel trick.

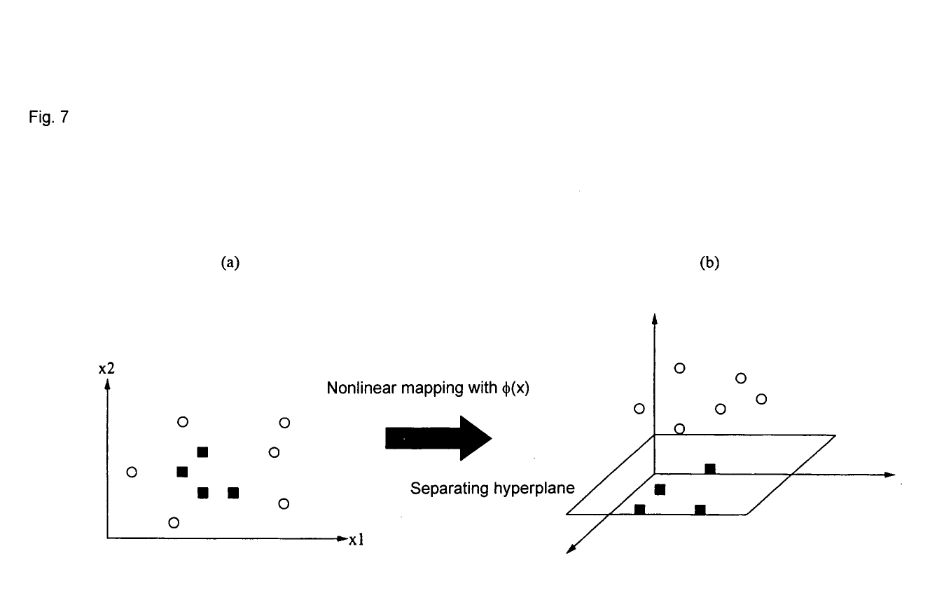

In the case where white circles and black squares are located in spots as shown in FIG. 7A, the two areas cannot be separated from each other by the d•1-dimensions (in the shown case, d=2 and therefore one-dimensional and linear). As shown in FIG. 7B, however, by preparing (assuming) a nonlinear map by φ(x), the two categories (white circles and black squares) can be separated from each other by the d•1-dimensional separating hyperplane (d=3 and therefore two-dimensional plane in FIG. 7A). In short, the original input data are mapped to a feature space of a higher dimension, and the linear separation is conducted in the feature space. With the increase in dimension, the calculation amount is increased. The calculation process, which is possible using the inner product, however, can be carried out easily.

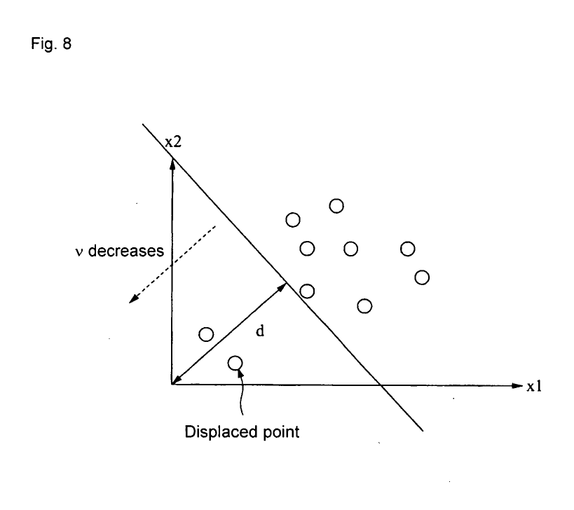

The one class SVM is a learning function to establish the discrimination function capable of discriminating the normality/abnormality of unknown data with high accuracy from the information including only the normal data. The identification plane obtained by the one class SVM is configured to fit on the outline of the sample data distribution. Specifically, data different from the sample data are discriminated as abnormal. The discrimination function of the one class SVM expanded nonlinearly by the Kernel conversion is given by the equation below.

$$f ( x ) = {\sum }_{i} ( {α}_{i} K ( {x}_{i} , x ) ) - ρ \qquad ( 3 )$$

where f(x) is the degree of deviation from the identification plane.
As a result, the normality/abnormality can be discriminated by the distance from the normal data mass. Specifically, the one class SVM is the Kernel method for determining the support at a sample point. In the case where the Gaussian function is used as the Kernel function, a point in the input space is detected as a deviation point taking advantage of the characteristic in which the deviation point is mapped to a point near the origin of the feature space (FIG. 8). In FIG. 8, ν designates the ratio of the sample group remaining on the origin (0>ν≧1). Thus, smaller the value ν, the more the deviation, i.e. the more abnormal.

The abnormality detection using the one class SVM is explained in terms of image. As shown in FIG. 5B, the products existing in a range where they are fitted on the outline (area indicated by dotted line) of a group indicating the normal range are determined as normal (conforming). Specifically, the area where the data have never appeared is detected as abnormal. Even in the case where the number of samples is small, therefore, the conformity/nonconformity discrimination can be made. Incidentally, although all the products located in other than this range can be detected as abnormal, a predetermined deviation degree is set as an alternative and the products with the deviation degree not less than a predetermined value can be detected as abnormal.

In short, the meaning of the abnormality degree in MTS and the one class SVM is such that the deviation degree from the distribution center is not less than a predetermined value in the former, and the deviation degree from the identification surface is not less than a predetermined value in the latter. The normal range in the one class SVM is an outline of a mass of a group of waveform data (feature amount values based on the waveform data) of the existing conforming products. With the addition of the data based on conforming products, therefore, the shape thereof is changed. Once the number of samples of the data collected is increased to such a degree as to form the normal distribution, the outline of the normal range in the one class SVM becomes equal to the range of the hyperellipsoid based on the normal distribution. Under this condition, the discrimination by MTS can be carried out with high accuracy, and therefore transfer to the discrimination based on MTS is possible. The shape of the conforming product group is not necessarily adapted to form a normal distribution, and even in the case where the normal distribution cannot be formed, the transfer to a parametric method is possible as suitable to each distribution with the known parametric method, such as the Weibull distribution or the binomial distribution.

Returning to FIGS. 3, 4, the apparatus according to this embodiment is explained. The abnormality detection model generating unit 12 includes a parameter optimizer 12a, a feature select dimension compressor 12b and a modeling unit 12c. According to this embodiment, the feature amount to be used is determined in advance. The parameter of the feature amount is automatically determined by the parameter optimizer 12a. The method of determining the parameter in the parameter optimizer 12a may be any appropriate conventional technique. The parameter thus determined is stored in the feature amount parameter data base 17.

The feature amount select dimension compressor 12b selects an effective one of a plurality of feature amounts, and compresses the high dimension feature amount to a low dimension. Specifically, according to this embodiment, the conformity/nonconformity discrimination is made with high accuracy and performance over a wider variety of objects, and a predetermined number of features are discriminated for each waveform based on the waveform in time domain and the waveform in frequency domain, respectively (generated by the waveform converter 13e). As a result, the number of feature amounts increases and are likely to increase in the future. As the result of incorporating a wide variety of feature amounts considered effective for conformity/nonconformity discrimination as described above, high-dimension feature vectors are generated and compressed while at the same time selecting the dimension effective for the normality/abnormality discrimination. The modeling unit 12c creates a model of the one class SVM (the range making up a group) or a model of MTS for the feature amount space of the waveform data based on conforming products, which model is stored in the abnormality detection model data base 18. Further, based on the model thus created, a fuzzy rule (including the membership function) used for fuzzy inference in the discrimination unit 15 is created and stored in the fuzzy rule data base 19. The fuzzy rule created and stored is either a rule for conformity/nonconformity discrimination in the transition period for overall discrimination including both the result of MTS and the result of the one class SVM, or a rule used for conformity/nonconformity discrimination by a single model (MTS or one class SVM). The rule to be created is described later.

The feature amount extractor 13, as shown in FIG. 4, includes a filter 13a for extracting and removing (filtering) a predetermined frequency component from a series of waveform data of the object to be inspected acquired through the A/D converter 5, a frame divider 13b for dividing the frame of the waveform data passed through the filter 13a, a waveform converter 13e for converting the waveform of the waveform data of each frame divided by the frame divider 13b, a frame feature amount calculator 13c for calculating the feature amount (frame feature amount) of each frame unit based on the waveform data of each frame unit divided by the frame divider 13b and the data (frame unit) converted by the waveform converter 13e, and a representative feature amount calculator 13d for determining, based on the frame feature amount, the representative feature amount of the waveform data to be inspected. The representative feature amount determined by the representative feature amount calculator 13d is sent to the abnormality detector 14 and the discrimination unit 15 in the next stage. The function of each processing unit of the feature amount extractor 13 is basically similar to that of the feature amount extractor mounted in the well-known noise inspection apparatus, etc.

The functions of each processing unit are briefly explained. The filter 13a is any of various filters such as a bandpass filter and a low-pass filter to remove noises and extract the frequency component required for discrimination and has various boundary frequency values set therein.

According to this embodiment, which is a form of abnormality detection, in which an abnormality is detected based on conforming products, a larger number of feature amounts is required as compared with the nonconformity identification. This is because in nonconformity identification, the noise generated by nonconforming products appears in the frequency band unique to the particular type of the particular noise. Since the frequency band generating the particular noise is known, the feature amount of only the particular frequency band is monitored in actual inspection. In abnormality detection, however, the frequency band cannot be specified for lack of nonconforming product data. During the inspection therefore, the feature amounts for all frequency bands are required to be monitored. Actually, however, the frequency range to be inspected can be empirically limited to a certain extent (though not to such an extent as in nonconformity identification). Also, as described later, the frequency analysis by FFT is also possible, and therefore the feature amounts can be analyzed over a wide frequency range.

The waveform data to be inspected is a continuous waveform having a predetermined length obtained by measuring a product to be inspected while being driven. The frame divider 13b divides the series of the waveform data into frame units each configured of a unit time (unit number of samples). In this dividing process, the series of waveform data are rendered to continue without any interruption between adjacent frames or with a part of the frame superposed on the adjacent frame. The waveform converter 13e is any of various types based on the Hilbert transform, FFT (Fourier transform), high-frequency emphasis, low-frequency emphasis and autocorrelation function.

The frame feature amount calculation unit 13c is any of various types based on the mean, distribution, skewness, kurtosis, number of peaks (number exceeding a threshold value) and maximum value. The representative feature amount calculation unit 13d determines the mean, maximum, minimum or change amount of the frame feature amount determined for each frame. The type of the frame feature amount calculated and the method of calculating the representative feature amount calculated based on the frame feature amount are not course limited to the aforementioned examples but various other types are applicable.

Actually, the feature amount extractor 13 reads the feature amount and the parameters (such as the boundary frequency of a filter or the threshold for determining the number of peaks) stored in the feature amount parameter data base 17, and in accordance with them, each processing unit executes the arithmetic operation.

The abnormality detector 14 includes a dimension compressor 14a, an SVM processor 14b and an MTS processor 14c. This results in the conformity/nonconformity discrimination is made with higher accuracy and performance over a wide variety of objects, so that a predetermined number of feature amounts are determined based on the waveform in time domain and the waveform in frequency domain (generated by the waveform converter 13e). As a result, the number of feature amounts increases and is liable to increase further in the future. As the result of incorporating a great variety of feature amounts considered effective for conformity/nonconformity discrimination in this way, a high-dimension feature vector is generated. The dimension compressor 14a executes the process of compressing the high-dimension feature vector while at the same time selecting the dimension effective for normality/abnormality discrimination.

The SVM processor 14b acquires the model (information indicating the normal range (outline)) for the one class SVM currently stored in the abnormality detection model data base 18, calculates the discrimination function (equation (3)) in the one class SVM described above, and determines the deviation degree f(x) from the identification plane in the feature amount space compressed in dimension based on the waveform data to be inspected. The result thus obtained is delivered to the discrimination unit 15 in the next stage.

The MTS processor 14c acquires the current MTS model (the position information of the hyperellipsoid indicating the normal range) stored in the abnormality detection model data base 18, and the Mahalanobis distance (equation (1)) is determined from the center of the hyperellipsoid in the feature amount space compressed in dimension based on the waveform data to be detected as described above. The result thus obtained is delivered to the discrimination unit 15 in the next stage.

The discrimination unit 15 includes a fuzzy inference unit 15a and a threshold processor 15b. The fuzzy inference unit 15a carries out the fuzzy inference in accordance with the rule stored in the fuzzy rule data base 19 based on the deviation degree of the one class SVM acquired from the abnormality detector 14, the Mahalabinos distance of the MTS and the representative feature amount value acquired from the feature amount extractor 13, and delivers the result of the fuzzy inference to the threshold processor 15b. The threshold processor 15b, in accordance with the obtained result of the fuzzy inference, discriminates the conformity/nonconformity of the product to be inspected. Though different in the model used, the fuzzy inference process and the conformity/nonconformity discrimination by the threshold processing based on the fuzzy inference process can basically use a similar mechanism to the prior art.

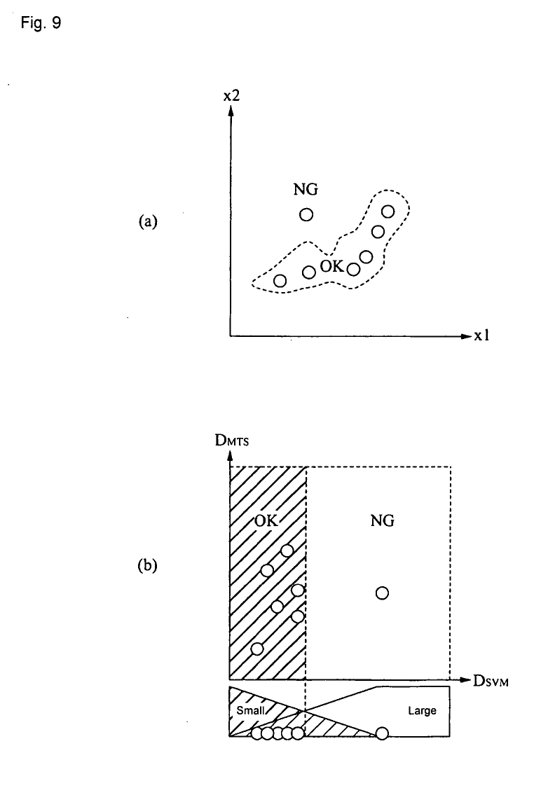

The distribution situation (distribution maturity) in each stage and the model/fuzzy rule used therefore are explained. In the initial stage of research and design, the number of sample data is small. The distribution of the feature amounts based on each sample data forms no normal distribution as shown in FIG. 9A, and the outline of the range based on conforming (normal) products fails to form a hyperellipsoid. For the convenience of explanation, two feature amounts (x1, x2) are shown on the two-dimensional plane. Actually, however, at least three feature amount spaces are involved.

As described above, in the initial stage in which a sufficient number of samples cannot be obtained, only the one class SVM is used, and therefore, as shown in FIG. 9B, the membership function as shown is prepared for only the deviation degree (abscissa) of the one class SVM. In the case where a small membership function is assigned to the conforming product range and a large membership function to the nonconforming product range, the adaptability to the large and small membership functions is equalized on the outline of the conforming product range. For example, both the membership functions are rendered to cross each other at 0.5. In the initial stage, no discrimination is made based on the MTS model and therefore no membership function is produced. As shown in FIG. 9B, therefore, the conformity/nonconformity discrimination is made based on only the membership function along the abscissa. The deviation degree of MTS is not determined, and therefore the membership function is not produced for the ordinate. Also, the learning data used for updating is the one determined as normal (conforming). Even the data determined as abnormal (nonconforming), however, can be added for the products determined as conforming by manual reinspection.

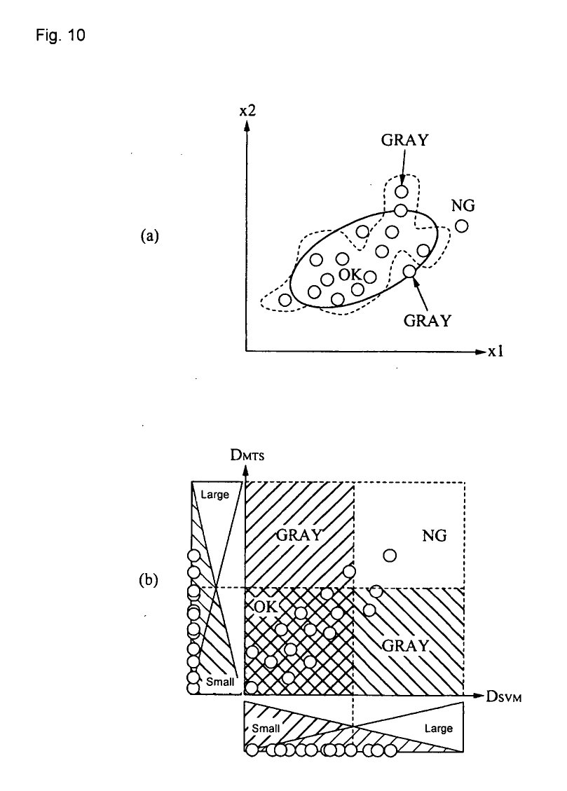

Once a certain number of samples (the data at least three times the number of feature amounts, for example) are collected upon transfer to the test mass production stage, the conformity/nonconformity discrimination by MTS becomes possible. In this stage, however, the distribution maturity can be estimated, but the multivariate normal distribution is not yet completed. Therefore, an unstable state prevails due to the error caused by deviation. As shown in FIG. 10A, therefore, the conforming product range (indefinite shape indicated by dashed line) based on the one class SVM model is not completely coincident with the conforming product range (shape of hyperellipsoid indicated by solid line) based on the MTS model. The data determined as normal based on the two models is determined as conforming, and the data determined abnormal based on the two models is determined as nonconforming. The data different between MTS and SVM is determined as “gray” (not definite or unclear).

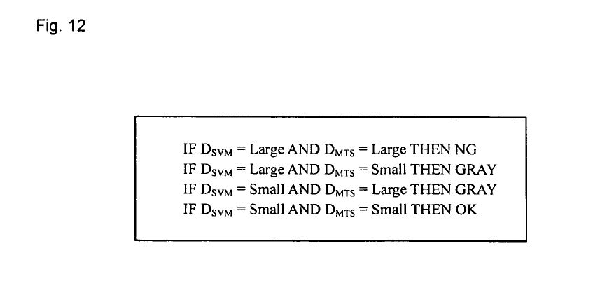

The membership function for this processing is similar to that in the initial stage for the one class SVM. With regard to the membership function for MTS, on the other hand, in the case where a small membership function is assigned to the conforming product range and a large membership function to the nonconforming product range, the adaptability to the large and small membership functions is equalized on the outline of the conforming product range. For example, the membership functions are crossed at 0.5. Also, the rule as shown in FIG. 12 is used.

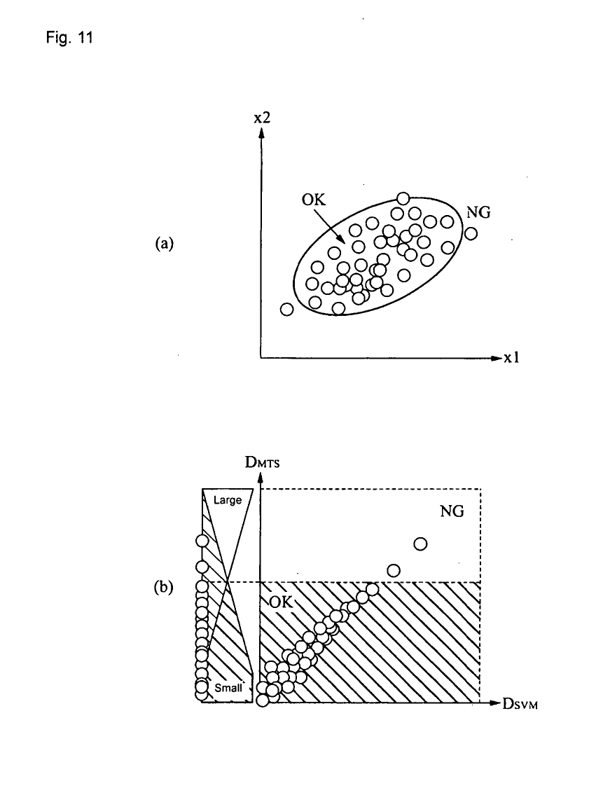

Further, upon transfer to the mass production stage where the multivariate normal distribution estimated with the distribution maturity is stable as shown in FIG. 11A, the conformity/nonconformity discrimination is made only by the MTS model as described above. This is due to the fact that the discrimination result between the two models are coincident in this stage where the conforming product range by the one class SVM assumes a similar shape to the hyperellipsoid. Therefore, unlike in the adjust stage, the discrimination process based on the two models is not required, only the MTS model. In this case, unlike the initial stage, the membership function is only for MTS. With regard to the membership function for MTS, in the case where a small membership function is assigned to the conforming product range, and a large membership function to the nonconforming product range, the adaptability to the large and small membership functions is equalized on the outline of the conforming product range. The two membership functions are crossed with each other, for example, at 0.5. Upon transfer to the stable stage, the model (discrimination rule) is not updated from time to time, and the distribution is checked for any change as required.

A particular process to be executed in each stage described above is determined by the applicable model selector 16, which sends a switch command to each processing unit (abnormal detector 14, the discrimination unit 15). Based on this command, each processing unit executes the process based on the designated model.

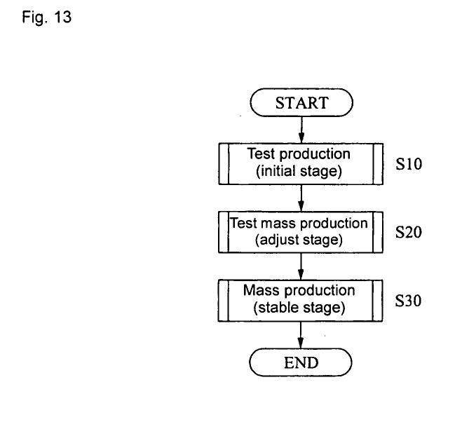

The inspection process with the above described inspection apparatus in described in detail hereafter. FIG. 13 is a flowchart showing the overall process of the inspection process. In the stage of transfer from development to production of an industrial product, for example, after the initial test production, the actual mass production may be started through the test mass production. According to the method shown in FIG. 13, in the transfer from development to production in three stages as described above, the conformity/nonconformity discrimination can be made from the initial test production stage (initial stage).

First, as shown in FIG. 13, the conformity/nonconformity discrimination process is executed in the initial test production stage (initial stage) (S10). In this initial stage, the sample data that can be acquired are few, and the conforming product distribution in the feature amount space or the shape of the normal area cannot be estimated. As an initial stage model, therefore, the conformity/nonconformity is discriminated only by the one class SVM.

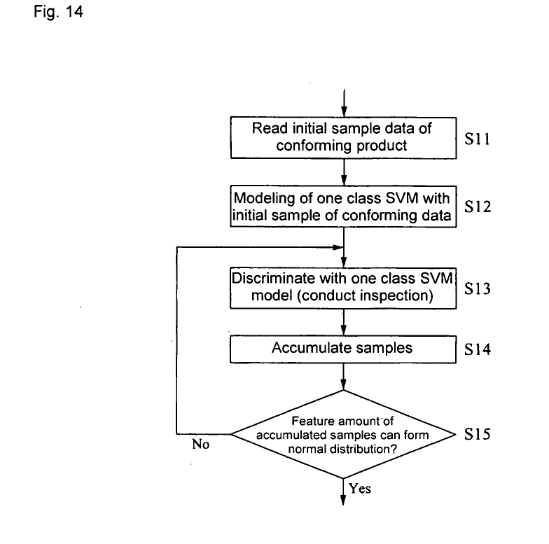

Specifically, the flowchart shown in FIG. 14 is executed. First, the initial sample data prepared for the conforming product is read (S11). The data thus read is stored in the waveform data base 11. Based on the waveform data stored in the waveform data base 11, the abnormality detection model generator 12 generates a model of the one class SVM (S12). The feature amount and the abnormality detection model thus prepared and the fuzzy rule are stored in the corresponding data bases 17, 18, 19, respectively. The processing steps S11, S12 are a learning stage, before which the conformity/nonconformity discrimination (noise inspection) is not made for the actually unknown waveform data. A predetermined number of sample data are prepared, and once the inspection by the one class SVM model based on the prepared sampling data becomes possible, the actual inspection at and after the processing step S13 is started.

Specifically, the waveform data based on the products (samples and test products) obtained in the initial test production stage are acquired and sent to the feature amount extractor 13 through the A/D converter 5, while at the same time being stored in the waveform data base 11. The applicable model selector 16 is set to operate only for the initial stage mode of the abnormal detector 14 and the discrimination unit 15, i.e. only for the one class SVM. As a result, the representative feature amount extracted by the feature amount extractor 13 is sent to the abnormality detector 14, and after being compressed in dimension by the dimension compressor 14a, the data thereof are sent to only the SVM processor 14b, where the deviation degree based on the one class SVM is determined and sent to the discrimination unit 15. The discrimination unit 15, based on only the one class SVM, carries out the fuzzy inference (FIG. 9) to determine conformity/nonconformity.

Next, samples are accumulated (S14). Specifically, the determination result of the inspection data (waveform data) for the inspection conduced at step S13 stored in the waveform data base 11 is registered as related to the waveform data stored. In the case of a conforming (normal) product, this is used for model preparation of the one class SVM. The abnormality detection model generating unit 12 may reconstruct the model each time a sample is added, or each time a predetermined amount of samples are accumulated. Also, as described later, while the conformity/nonconformity discrimination based on the one class SVM model is going on, only new sample data are accumulated but the model may not be reconstructed based on the accumulated samples. Preferably, however, the model is reconstructed at appropriate timing as required. By doing so, more samples are extracted as conforming products (the discrimination of an originally conforming product as abnormal is avoided).

While the inspection process is executed by the one class SVM alone in the initial stage, the conformity/nonconformity discrimination is made based on the models determined by execution of steps S11, S12, but the one class SVM model may not be reconstructed based on new samples obtained by the execution of step S14.

In the foregoing description, the waveform data to be inspected are stored in the waveform data base 11 as soon as applied to the feature amount extractor 13 for inspection (without waiting for the conformity/nonconformity discrimination result). This invention is not limited to such operation, but step S13 is executed and only the products determined as conforming may be stored in the waveform data base 11. In this case, the waveform data applied through the A/D converter 5 are stored in a buffer memory or other primary storage means before the discrimination result is made clear, and after the determination result becomes clear, the waveform data stored in the primary storage means is stored in the waveform data base 11. The waveform data determined as nonconforming (abnormal) are discarded (erased) or stored in another data base. Also in this case, they may alternatively be stored in the waveform data base 11 in the form identifiable as a waveform data based on a nonconforming product.

It is determined whether the feature amount of the accumulated samples can form the normal distribution or not (S15). This determination is conducted by the applicable model selector 16. In FIG. 3, for the convenience of illustration, the applicable model selector 16 is connected only with the abnormality detector 14 and the discrimination unit 15 to send and receive the data. Nevertheless, other processing units and data bases can also be accessed. According to this embodiment, the applicable model selector 16 or the waveform data base 11 are accessed, and the determination is made according to whether the sample data of conforming products stored therein have reached a sufficient number to estimate the conforming product distribution (discrimination based on the MTS model). Specifically, it is determined that the number of samples is at least not less than the number of the feature amounts, and according to this embodiment, it is determined whether the number of samples is at leas three times the number of feature amounts. In the case where the number of samples of conforming products remains not more than three times (less than three times) the number of the feature amounts, the branch determination is NO, and the process returns to step S13 to execute the inspection process for the next product (test product). In the case where the branch determination at step S15 is YES, on the other hand, the conformity/nonconformity discrimination process (S10) for the initial test production (initial stage) shown in FIG. 13 is completed, and the process proceeds to the next stage, i.e. the conformity/nonconformity discrimination for the test mass production (adjust stage) (S20). According to this embodiment, the estimation as to whether the feature amounts assume the normal distribution or not is based on the number of the feature amounts and sample data. Nevertheless, this invention is not limited to such a method, but can determine a normal distribution or not simply using the indexes of skewness and kurtosis, for example, based on the distribution situation of the value of the feature amounts determined.

In the test mass production stage, the sample data that can be acquired increase in number and the distribution of conforming products can be estimated, but the shape of the normal area is unstable due to the error caused by deviation. As a model of the adjust stage, therefore, the discrimination process based on the one class SVM model and the discrimination process based on the MTS model are used at the same time to make overall discrimination (S20).

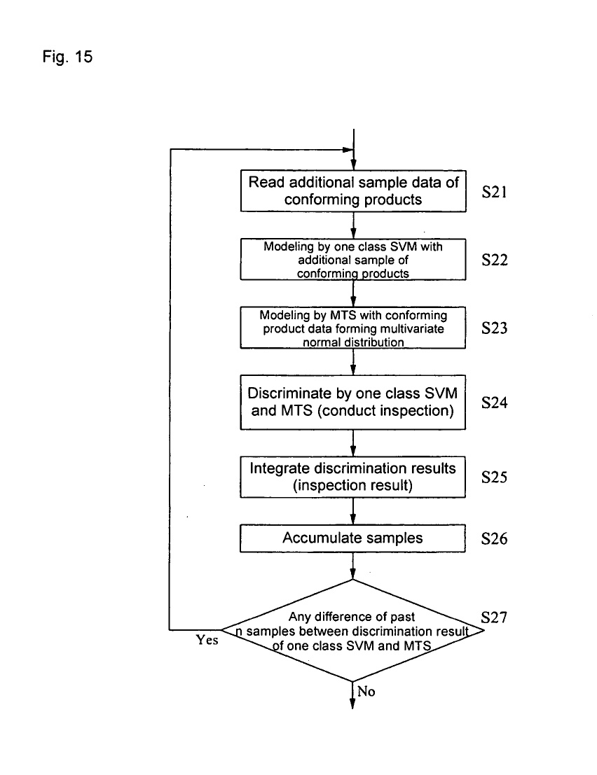

Specifically, the flowchart shown in FIG. 15 is executed. First, the sample data of conforming products is additionally read (S21). Including the added sampled data, the modeling of the one class SVM is carried out again (S22). In the case where the reconstruction of the one class SVM model is repeated in the initial stage based on the samples kept additionally accumulated, the process of step S22 is not specifically required. In any case, however, the modeling of MTS (S23) is required next, and therefore, the waveform data on the conforming products including the added ones is required to be read at S21. The feature amounts, the abnormality detection models and the fuzzy rule determined by each modeling are stored in the data bases 17, 18, 19, respectively.

In accordance with the one class SVM model and he MTS model created by execution of steps S21 to S23, the discrimination is made based on the waveform data obtained from the product to be inspected (S24), and by integrating the discrimination result, the inspection result is output (S25).

Specifically, the applicable model selector 16 sets the abnormality detector 14 and the discrimination unit 15 to operate in the adjust stage mode, i.e. with both the one class SVM and MTS. As a result, the representative feature amount extracted by the feature amount extractor 13 is sent to the abnormality detector 14, and after being compressed in dimension by the dimension compressor 14a, the related data are sent to both the SVM processor 14b and the MTS processor 14c, in each of which the deviation degree based on the one class SVM model and the deviation degree based on the MTS model are determined and sent to the discrimination unit 15. The discrimination unit 15 carries out the fuzzy inference (FIG. 10) and normality/abnormality discrimination based on the deviation degree of both the one class SVM and MTS. According to this embodiment, as explained with reference to FIG. 10, the discrimination process using each model at step S24 and the integration of the discrimination processes are collectively carried out by the fuzzy inference. Nevertheless, they can be executed separately from each other.

Next, samples are accumulated (S26). Specifically, the waveform data of the object to be inspected obtained at step 24 are stored in the waveform data base 11. In the process, the discrimination result (inspection result) is also stored. The waveform data can be stored at any of various timings as in the initial stage described above.

It is then determined whether the discrimination result is different between the one class SVM and MTS for the past n samples (S27). Specifically, it is determined whether the inference result obtained by the fuzzy inference unit 15a is gray or not. In the presence of gray, it is determined that there is a difference. The presence or absence of gray can be determined in such a manner that a difference exists in the case where even one of the past n samples is determined as gray and no difference exists in the case where the number of gray determination is not more than a predetermined number. This determination is made by the applicable model selector 16.

In the case where there is any difference, the process returns to step 21 and the aforementioned process is repeatedly executed. Once the difference is eliminated, the conformity/nonconformity discrimination process (S20) for the test mass production (adjust stage) shown in FIG. 13 is completed, followed by the next stage, i.e. the conformity/nonconformity discrimination in mass production stage (stable stage) is started (S30). According to this flowchart, in the case where the branch determination at step 27 is YES, the process returns to step S21. Each time the inspection is conducted for each waveform data, therefore, the modeling reconstruction is carried out. Nevertheless, the invention is not limited to such a case, but the process may return to step S24 and the inspection may be conducted without modeling reconstruction before the additional accumulation of a predetermined number of samples.

The mass production stage is a state in which a sufficient amount of sample data can be acquired and the conforming product distribution and the shape of the normal area are stable. The discrimination process based only on the MTS model as a stable stage model is carried out (S30).

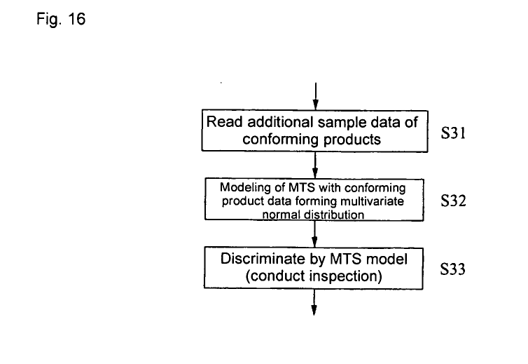

Specifically, the flowchart shown in FIG. 16 is executed. First, the sample data of conforming products are additionally read (S31). As long as the model reconstruction of MTS is repeatedly executed based on the samples additionally kept accumulated in the adjust stage process, the process of step S31 is not necessarily provided. The MTS modeling is carried out with the collected sample data of conforming products including the added sample data, i.e. the conforming product data formed with the multivariate normal distribution (S32). The feature amount, abnormality detection model and the fuzzy rule obtained by modeling are stored in the data bases 17, 18, 19, respectively. After that, the discrimination (conformity/nonconformity discrimination) with the MTS model is carried out (S33).

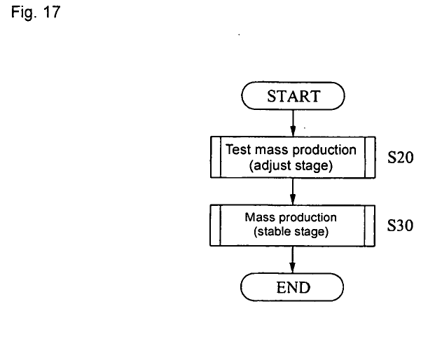

FIG. 17 shows a second embodiment of the invention. The stage of transfer from development to production of an industrial product, for example, roughly includes the test mass production and the mass production. In such a case, the conformity/nonconformity discrimination process in the initial test production stage (initial stage) according to the first embodiment is eliminated, and the conformity/nonconformity discrimination using both the one class SVM and MTS is carried out in the test mass production stage (adjust stage) (S20). Once the mass production (stable stage) is started, the conformity/nonconformity discrimination is conducted only based on MTS (S30).

The specific process flow in each stage is similar to the corresponding flow in the first embodiment (FIGS. 15, 16), and therefore not described in detail. Also, the second embodiment is applicable to the stages with the development started with the initial test production (initial stage) as in the first embodiment.

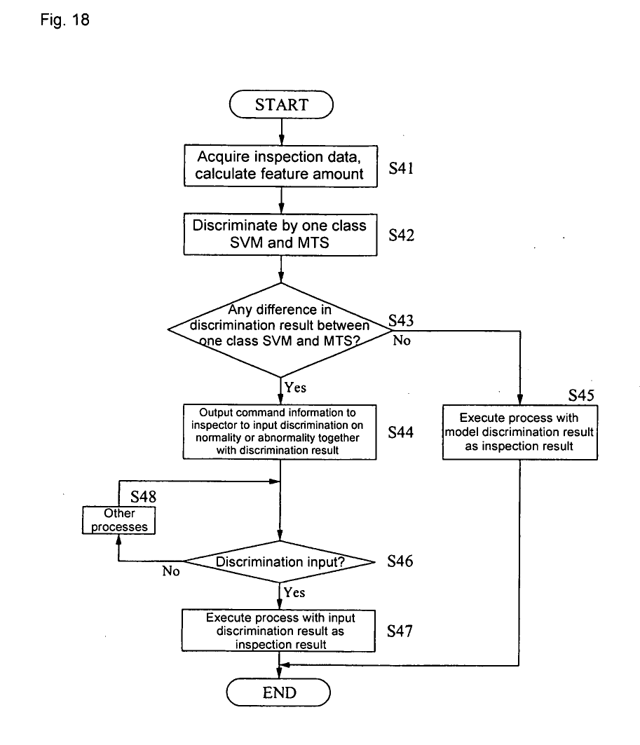

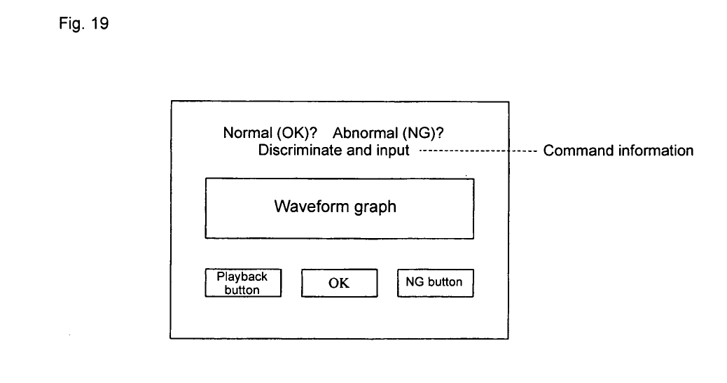

FIGS. 18, 19 show a third embodiment of the invention. According to each embodiment described above, in the presence of a difference of the discrimination result between the one class SVM and MTS in the adjust stage, the discrimination result “gray” is output. Although the gray state can be left as it is, a specific processing function of the normality/abnormality discrimination by human being is introduced for rapid transfer to the stable stage.

Specifically, as shown in FIG. 18, the inspection data is acquired first of all, and the feature amount extractor 13 calculates the feature amount (S41). The deviation degree of the feature amount (representative feature amount) thus acquired is determined based on the one class SVM model and the MTS model thereby to conduct the conformity/nonconformity discrimination (S42). This process is equivalent to step S24 shown in FIG. 15.

It is determined whether there is any difference of the discrimination result between the one class SVM and MTS (S43). Specifically, it is determined whether the fuzzy inference result by the fuzzy inference unit 15a of the determining unit 15 is gray or not. In the case of coincidence, the model discrimination result (normality/abnormality) is processed as the inspection result (S45). In other words, the inspection result is displayed on a display unit or stored in the waveform data base 11.

In the case where there is any difference between the discrimination results based on the two models, on the other hand, the discrimination results, together with a command information to input the determination on normality or abnormality, are output to the inspector. As this command information, as shown in FIG. 19, for example, a discrimination input screen can be displayed on the display unit. The waveform data 11 of the product to be inspected are read out from the waveform data base 11 or the temporary storage means and output to the column in the waveform graph. In the case where the “playback button” is clicked on the discrimination input screen, the sound is reproduced and output based on the waveform data indicated in the waveform graph. As a result, the person making the determination discriminates whether a particular product is conforming (normal) or nonconforming (abnormal) based on the waveform graph or the reproduced sound, followed by clicking either the “OK” button or the “NG” button.

The inspection apparatus executes the step S44, and when the discrimination input screen including the command information is displayed, waits for the arrival of the discrimination input (S46), while in the case where no discrimination input is input, executes a predetermined process (voice reproduction in the aforementioned case) (S48). Once the normality/abnormality discrimination is input, the process is executed with the input discrimination result as the inspection result (S47). Specifically, the discrimination result is corrected and displayed, the information to be registered in the waveform data base 11 is updated, or the model is reconstructed. Especially, in the case of the one class SVM, it is determined whether the conforming product group range is involved or not, and therefore, by the manual correction at the appropriate timing, the conforming product range can approach the hyperellipsoid at an early time.

As an alternative, in the case where the discrimination result for the added sample is different between the adjust stage model and the stable stage model (in the case where the same sample is determined as normal on the one hand and determined as abnormal on the other hand), manual correction is possible using a mechanism similar to the one described above.

The inspection apparatus 10 according to the aforementioned embodiment is applicable to the inspection fields including the noise, the assembly error and the output characteristics. The apparatus can also find an application in both the in-line system for mass production and the off-line system for inspection of test products apart from the mass production. More specifically, the inspection apparatus 10 according to this embodiment can be used as an inspection machine for the automotive vehicle drive modules such as the engine (sound) and the transmission (vibration), an inspection machine for the automotive motor actuator modules such as the electric door mirror, the electric power seat and the electric column (positioning of the steering wheel), an evaluation device for the noise, the assembly error and the output characteristics, or an evaluation device for a test product under development.

Also, the invention is applicable as an inspection machine for the motor-driven home electric appliances such as the refrigerator, the indoor/outdoor units of the air conditioner, the electric washer, the electric cleaner and the printer, or an evaluation device for the noise, the assembly error or the output characteristic of the home electric appliances under development.

Further, the invention is applicable as an equipment diagnosis device for determining the condition (abnormal/normal) of the equipment such as the NC machine tool, the semiconductor plant or the food plant. This is based on the idea that the normality/abnormality discrimination is made only based on the sample data for the normal operation unlike in the prior art where the existing fact and the fixed concept are that the discrimination formula (discrimination rule) to check for the presence or absence of an abnormality in equipment diagnosis is created based on the sample data for the abnormality. Immediately after the equipment device is introduced, it is common practice to operate the device while adjusting it (or while adjusting and changing the setting of the operation parameters). Therefore, the abnormal state occurs in an unstable manner, and can be prevented by maintenance or appropriate device adjustment.

Specifically, once the equipment device enters the stable operation period, some of the abnormalities can be prevented by employing a solution. This indicates that the disappearance of some of the “abnormal states” in the equipment device status discrimination is a phenomenon similar to the suppression of generation of some of the “nonconforming products” to be inspected, and also indicates that the invention is applicable as an equipment diagnosis device for determining the status (abnormal/normal) of the equipment. In an application to the equipment diagnosis device, the “initial state” corresponds to the stage before stable operation of the equipment. With regard to the knowledge of the abnormality type, the points of the equipment devices requiring the periodic maintenance and adjustment become clear due to the secular variation thereof after the stabilization of the operation of the equipment device. Thus, the knowledge on the conformity/nonconformity discrimination is developed by specifying the abnormal state (the presence and type of an abnormality) and using the data for each abnormality type. Once a solution is applied as a knowledge of the conformity/nonconformity discrimination and the abnormality ceases to occur, the knowledge on the particular abnormality type is deleted and the discrimination process executed without the knowledge.

Also, the equipment is not limited to plants, but includes vehicles such as cars and airplanes on the one hand and the invention is applicable as a diagnosis device for determining the status of various articles on the other. Take a vehicle as an example. The normal knowledge is generated based only on the data on the normal engine state in the test production stage. Although abnormalities may naturally occur during the test production, some of the abnormalities cease to occur due to the improvement. In the initial stage of test production, therefore, the discrimination rule is created only from the normal data, and in the stage near completion in which the abnormalities cease to occur due to the improvement of the test product, several abnormality types are specified and the knowledge on abnormality types is generated from the data of the abnormal states. By doing so, the normal state and specified abnormal states can be determined. In this way, the data and knowledge are accumulated from the test production stage, and using the knowledge of normality and the abnormality types, a diagnosis device is produced to discriminate the normality/abnormality and determined a particular abnormality type. This diagnosis device is mounted on a car or an airplane placed on the market as a complete product and can be used to diagnose a normality or an abnormality based on the engine vibration.

1. An inspection method for extracting the feature amount of the input measurement data and discriminating the conformity/nonconformity of an object to be inspected, based on the extracted feature amount, comprising the steps of:
discriminating the conformity/nonconformity of a product in accordance with a model based on the normality data obtained from a conforming product;
discriminating the conformity/nonconformity of a product based on the result of discrimination of the measurement data of the object to be inspected, according to both a parametric discrimination model and a nonparametric discrimination model in an adjust stage where a sufficient amount of sample data cannot be acquired or the conforming product distribution in the feature space is unstable and therefore the estimation accuracy of the shape of the normal area is not sufficient; and
discriminating the conformity/nonconformity of the product based only on the result of discrimination of the measurement data of the object to be inspected, according to the parametric discrimination model in a stable stage where a sufficient amount of sample data can be acquired and the conforming product distribution and the shape of the normal area is stable.

2. An inspection method according to claim 1,
wherein the transfer from the adjust stage to the stable stage is conducted in the case where the ratio of coincidence between the conformity/nonconformity discrimination result according to the nonparametric discrimination model and the conformity/nonconformity discrimination result according to the parametric discrimination model in the adjust stage is not less than a predetermined value.

3. An inspection method according to claim 1,
wherein in the case where the result of the conformity/nonconformity discrimination according to the parametric discrimination model and the result of the conformity/nonconformity discrimination according to the nonparametric discrimination model are different from each other in the adjust stage, the discrimination result by the human being is employed as the final result of the conformity/nonconformity discrimination for the measurement data of the object to be inspected.

4. An inspection method according to claim 1,
wherein the MTS is used as the parametric discrimination model and the one class SVM is used as the nonparametric discrimination model.

5. An inspection method for extracting the feature amount of the input measurement data and discriminating the conformity/nonconformity of an object to be inspected, based on the extracted feature amount, comprising the steps of:
discriminating the conformity/nonconformity of the product in accordance with a model based on the normality data obtained from a conforming product;
discriminating the conformity/nonconformity of the product based only on the result of discrimination of the measurement data of the object to be inspected, according to the nonparametric discrimination model in an initial stage where only a few sample data can be acquired and the conforming production distribution in the feature space and the shape of the normal cannot be estimated;
discriminating the conformity/nonconformity of the product based on the measurement data of the object to be inspected, according to both the parametric and nonparametric discrimination models, and determining the conformity/nonconformity of the product using the result of both the parametric and nonparametric discrimination models in an adjust stage where a sufficient amount of sample data cannot be acquired or the shape of the conforming product distribution in the feature space is unstable and the accuracy of estimation of the shape of the normal area is insufficient; and
discriminating the conformity/nonconformity of the product based on the measurement data of the object to be inspected, according to only the result of the parametric discrimination model in a stable stage where a sufficient amount of sample data can be acquired and the conforming product distribution and the shape of the normal area are stable.

6. An inspection method according to claim 5,
wherein the transfer from the initial stage to the adjust stage is conducted in the case where the number of samples collected is larger than at least the number of the feature amounts.

7. An inspection method according to claim 5,
wherein the transfer from the adjust stage to the stable stage is conducted in the case where the ratio of coincidence between the conformity/nonconformity discrimination result according to the nonparametric discrimination model and the conformity/nonconformity discrimination result according to the parametric discrimination model in the adjust stage is not less than a predetermined value.

8. An inspection method according to claim 5,
wherein in the case where the result of the conformity/nonconformity discrimination according to the parametric discrimination model and the result of the conformity/nonconformity discrimination according to the nonparametric discrimination model are different from each other in the adjust stage, the discrimination result by the human being is employed as the final result of the conformity/nonconformity discrimination for the measurement data of the object to be inspected.

9. An inspection method according to claim 5,
wherein the MTS is used as the parametric discrimination model and the one class SVM is used as the nonparametric discrimination model.

10. An inspection apparatus for extracting the feature amount of the input measurement data and discriminating the conformity/nonconformity of an object to be inspected, based on the extracted feature amount:
wherein the conformity/nonconformity discrimination is carried out in accordance with a model generated based on the normal measurement data obtained from a conforming product;
the apparatus further comprising the function of discriminating the conformity/nonconformity according to the parametric discrimination model and the function of discriminating the conformity/nonconformity according to the nonparametric discrimination model;
wherein the function of discriminating the conformity/nonconformity according to the parametric discrimination model and the function of discriminating the conformity/nonconformity according to the nonparametric discrimination model include a control device for controlling and permitting one of the functions to be executed alone or both of the functions to be executed at the same time;
the control device performing the control operation in such a manner that:
both the function of discriminating the conformity/nonconformity according to the parametric discrimination model and the function of discriminating the conformity/nonconformity according to the nonparametric discrimination model based on the measurement data of the object to be inspected are executed and the conformity/nonconformity is finally discriminated based on the discrimination results of the two functions in an adjust stage where a sufficient amount of sample data cannot be acquired or the shape of the conforming product distribution in the feature space is unstable so that the estimation accuracy of the shape of the normal area is not sufficient; and
the conformity/nonconformity is discriminated based only on the function of discriminating the conformity/nonconformity based on the measurement data of the object to be inspected, according to the parametric discrimination model in a stable stage where a sufficient amount of sample data can be acquired and the shape of the conforming product distribution and the shape of the normal area are stable.

11. An inspection apparatus according to claim 10,
wherein the control device includes the function of carrying out the conformity/nonconformity discrimination on the measurement data of an object to be inspected, based only on the nonparametric discrimination model in an initial stage where the sample data that can be acquired are not sufficient and the shape of the conforming product distribution in the feature space and the shape of the normal area cannot be estimated.

12. An inspection apparatus according to claim 10, further comprising a model generating device for generating a model for abnormality detection based on the normal measurement data obtained from a conforming product,
wherein the function of discriminating the conformity/nonconformity according to the parametric discrimination model and the function of discriminating the conformity/nonconformity according to the nonparametric discrimination model are executed based on the model generated by the model generating device.

13. An inspection apparatus according to claim 12,
wherein the normal measurement data used by the model generating device to generate a model includes the measurement data for the object to be inspected, determined as a conforming product.

14. An inspection apparatus according to claim 10, further comprising:
the function of displaying an input screen for receiving the input of the result of discrimination by the human being and the function of using the discrimination result input based on the input screen as the final conformity/nonconformity result for the measurement data of the object to be inspected, in the case where the conformity/nonconformity discrimination result according to the nonparametric discrimination model and the conformity/nonconformity discrimination result according to the parametric discrimination model are different from each other.

15. An inspection apparatus according to claim 10,
wherein the function of discriminating the conformity/nonconformity according to the parametric discrimination model uses the MTS and the function of discriminating the conformity/nonconformity according to the nonparametric discrimination model uses the one class SVM.
